(19) United States
(12) Patent Application Publication
(10) Pub. No.: US 2006/0103926 A1
(43) Pub. Date: May 18, 2006

(54) Telescope system and method of use

(75) Inventors: Seth Meyers, Accord, NY (US); David William Whipps, Toronto (CA)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Imaginova Corporation

(21) Appl. No.: 11/271,451

(22) Filed: Nov. 11, 2005

Related U.S. Application Data
(60) Provisional application No. 60/626,860, filed on Nov. 12, 2004.

(51) Int. Cl. G02B 23/00

(52) U.S. Cl. 359/430; 359/399

(57) ABSTRACT

The present invention provides a telescope system having enhanced capabilities for configuring and calibrating a telescope, operation and control of the telescope, and viewing of images from the telescope. The present invention employs a control system for controlling the position and orientation of the telescope. In one embodiment, the system uses GPS systems and the like to determine the position of the telescope. The system may use either the light detected by the telescope or measurements of stars within the field of view to determine the orientation of the telescope. Following calibration, the user may operate a control system to reorient the telescope to a desired field of view. Further, the user may operate software that allows the user to select stars, constellations, or other objects of interest. Based on this selection, the system operates the telescope to alter it field of view to the view the selected object.

### CROSS-REFERENCE TO RELATED APPLICATIONS

The present application claims priority from U.S. Provisional Patent Application No. 60/626,860, filed Nov. 12, 2004 and entitled: TELESCOPE SYSTEM AND METHOD OF USE, the contents of which are incorporated herein by reference.

### BACKGROUND OF THE INVENTION

1. Field of the Invention

The present invention relates to a telescope system and method for conducting celestial observation and data collection and more particularly, to a telescope system including improved systems and methods for alignment and/or calibration of the telescope.

2. Description of the Related Art

Telescopes allow greatly improved viewing of objects, particularly stars, planets and other celestial bodies. Generally, telescopes include numerous moving parts and specialized components, such as lenses. Proper operation of a typical telescope relies on principles based in physics, optics, and astronomy, among others. Consequently, the average user generally has a difficult time operating a traditional telescope.

For example, traditional telescopes (see, e.g., FIG. 1) are not easy to calibrate once initially set up. Conventional telescopes typically require that the user calibrate the telescope (directionally) based on identification of one or more celestial objects. Thus, for initial use of the telescope, the user must locate a specific coordinate in the sky from which to calibrate the telescope and to provide a baseline point of reference from which other coordinates can be calculated. While most users are able to readily identify the moon or the sun, it is typically challenging for users to identify other bodies in the sky, such as the North Star.

Traditional telescopes have been updated to include processors and other computerized elements (see, e.g., FIG. 2), which allow access to databases of information, such as coordinates for known celestial bodies. The processors generally provide the user with a cross-reference, indicating what celestial body exists at specific coordinates, or conversely provide the coordinates for a specific or targeted celestial body. However, the fact that a telescope has an accessible database of coordinates and celestial body registries does not necessarily mean the telescope is easier to use. Users still must manually find coordinates to properly position the telescope. Thus, calibrating and positioning the telescope remains difficult for the average user of these systems.

There remains an unmet need in the art for a telescope system that is fully automated and easy to use. Specifically, there is an unmet need in the art for a telescope system that can calibrate itself with little to no manual input from the user. There is also an unmet need for a telescope system that can position the telescope to target specific coordinates or bodies requested by the user, to allow photographic or other information collection, and to allow remote use.

### BRIEF SUMMARY OF THE INVENTION

The present invention provides systems and methods for calibrating and controlling a telescope. In one embodiment, the present invention includes a telescope. The telescope is mounted to a tripod or other structure. A control system is connected to the telescope for orienting the telescope. The control system may comprise a controller connected to one or more motors for orienting the telescope.

In one embodiment, the system includes a position sensing system to determine the position, e.g., latitude and longitude, of the telescope. The position system may comprise a GPS system locates the position of the telescope and may also determine the time of day for the geographic location of the telescope.

The system may also include an orientation sensing system for determining position mounting information. The orientation system may include encoders or other systems to detect orientation, as well a compass or other directional feature for determining compass direction orientation of the telescope, and a level or other gravitational device, such as accelerometers positioned in X,Y, and Z axes, for determining the orientation of the telescope and/or mount relative to the Earth's surface.

The present invention provides one or methods for calibrating the telescope system. In a first embodiment, the system employs software that includes a constellation reproduction or projection component usable by the present invention to match (e.g., via overlapping comparison) received light information from the telescope with constellation information to allow automatic or fine-tuning of the orientation and/or focus of the telescope.

In another embodiment, the present invention may use methods to match received light with constellation information. The method studies images received from the telescope and using the algorithms to determine based on angular separation of the stars in the field of view to identify stars and/or constellations.

Once the telescope is calibrated, the present invention allows the user to easily navigate the telescope. For example, the user may operate either through direction connection or wireless a system to change orientation of the telescope. In some embodiments, the user may input desired coordinates, which are then used to control the orientation of the telescope. In other embodiments, the system may include software that allows a user to view representations of the sky and select from the interface objects of interest. Based on this selection, the telescope is oriented to the desired field of view.

The present invention also provides various options for capturing views from the telescope. In some embodiments, a traditional eye piece may be employed. In other embodiments, the field of view may be captured by a digital camera or similar system. Further, in some embodiments, the system may allow the digital image to be transferred to a computer, TV, home entertainment system, etc.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exemplary standard telescope of the prior art;

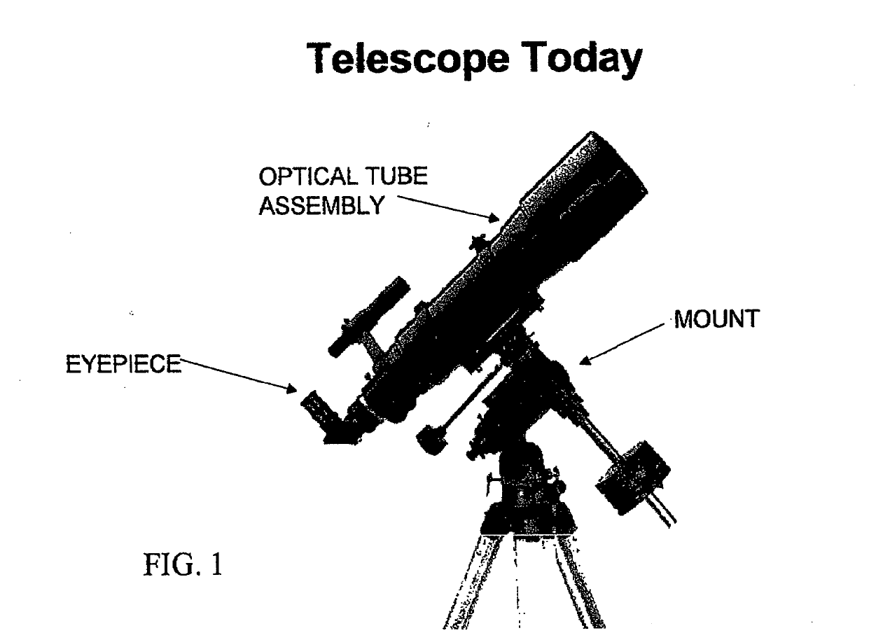

FIG. 2 is an exemplary “advanced” telescope of the prior art, which includes a hand controller and connection to a computer;

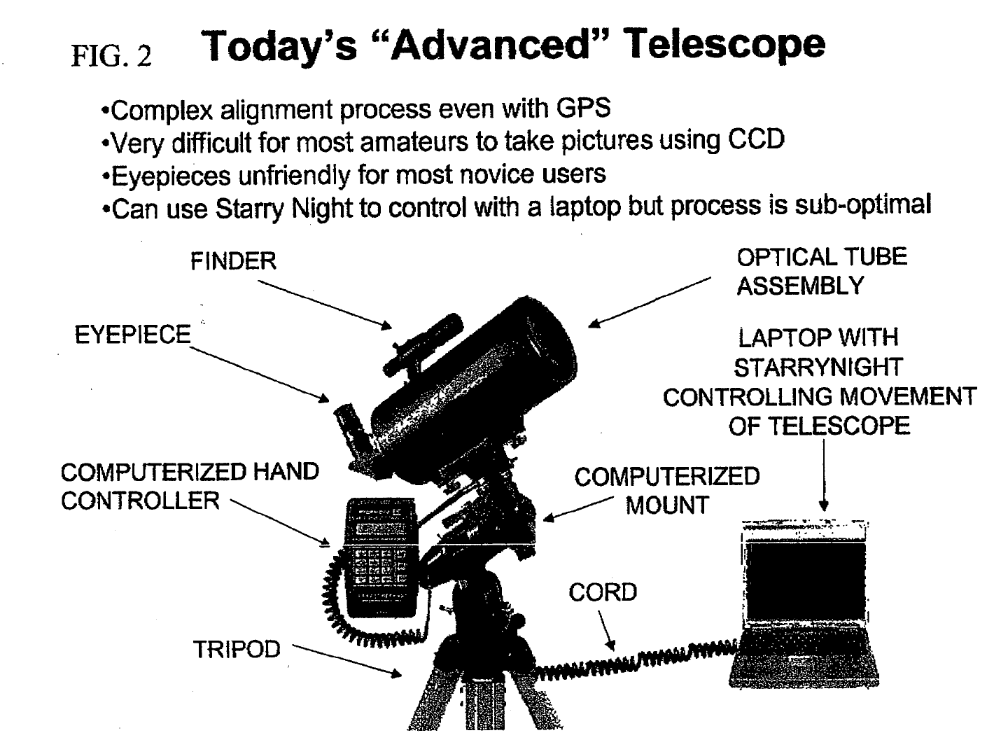

FIG. 3 presents a schematic overview of an exemplary telescope system, in accordance with one embodiment of the invention, in which the telescope is coupled to a processor and/or various other peripheral devices;

FIG. 4 presents a schematic overview of a telescope system, in accordance with one embodiment of the invention, in which the telescope is wirelessly coupled with an exemplary remote device, such as a personal digital assistant;

FIG. 5 shows an exemplary telescope system in accordance with an embodiment of the present invention;

FIG. 6 illustrates an exemplary home theater system for use with received telescope image information, in accordance with an embodiment of the present invention;

FIG. 7 presents an exemplary system diagram of various hardware components and other features, for use in accordance with an embodiment of the present invention;

FIG. 8 presents a block diagram of an embodiment of the present invention; and

FIG. 9 is a flow chart illustrating steps associated with a method for automatically orienting a telescope according to an embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention meets the above-mentioned as well unstated needs in the art by providing a telescope system that is one or more of 1) user friendly and automated, 2) can collect and export information and data, 3) allows optional remote operation, including remote viewing via a camera component, and/or 4) automatically calibrates and positions the telescope.

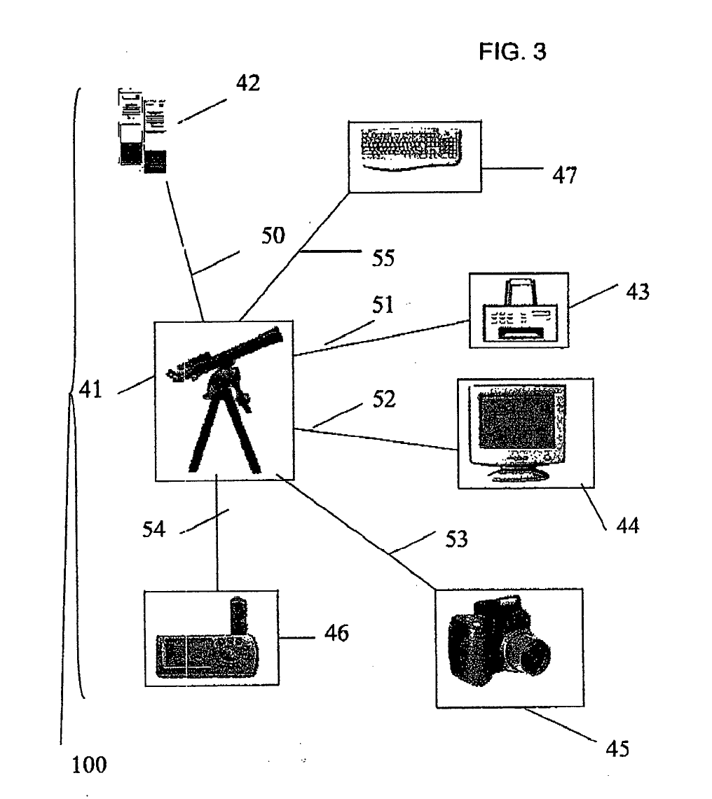

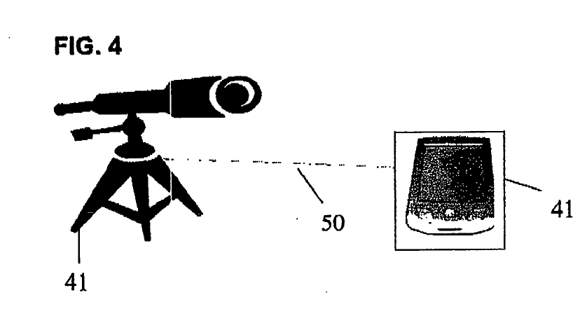

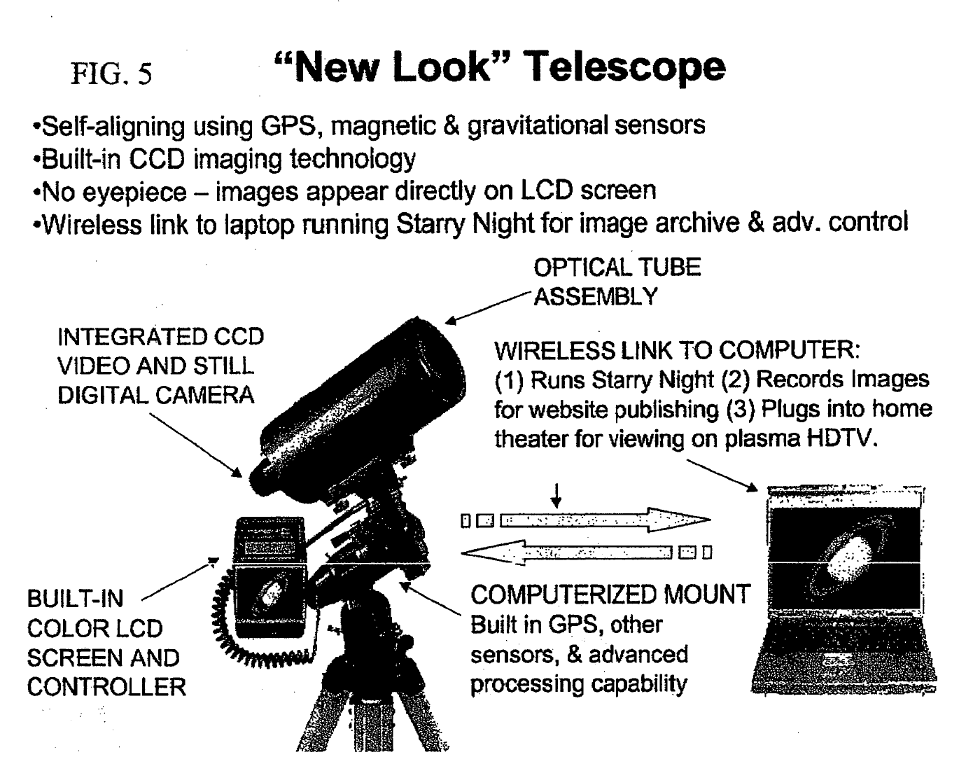

As illustrated in FIGS. 3-4 and the pictograph of FIG. 5, the present invention provides a telescope system 100 that includes a telescope component 41, a Geographical Positioning System (GPS) component 46 for locating the position of the telescope and receiving time of day information for the geographic location (which is important for determining celestial positions, as described further below), a motorized or otherwise controllable mount with additional positioning control components, a camera component 45 for viewing images received by the telescope component 41, and a processor 42 with processor interface components and/or couplings 50-55 for connection to a processor. In one variation, the telescope system 100 includes motorized or other control components for controlling the telescope focus and other telescope adjustments. In another variation, the processor 42 utilizes GPS 46 information and received mount positioning information (e.g. encoder or other information as to the orientation of the mount and/or telescope portions, compass or other directional feature for determining compass direction orientation of the telescope, and a level or other gravitational device, such as accelerometers positioned in X,Y, and Z axes, for determining the orientation of the telescope and/or mount relative to the Earth's surface) to orient and otherwise control the telescope 41, via the mount and/or other control features and, to direct the telescope 41 to an inputted or preselected astral position.

In one embodiment, the telescope system 100 is attached to a stationary positioning device, such as a tripod or other mount. The mount generally holds the telescope 41 steady. The mount also allows the telescope 41 to have multidirectional movement, so as to enable positioning of the telescope 41 to target celestial bodies for viewing. In one variation, the GPS component, compass or other directional component, and level or other gravitational component are each located in or on the mount.

The present invention is not limited to a particular stationary positioning device. An exemplary mount that could be used as a component of the present invention is an altitude-azimuth mount. This mount has two axes of rotations: vertical and horizontal. Rotation around the vertical axis positions the telescope in the azimuthal dimension; rotation around the horizontal axis positions the telescope in the altitude. In one embodiment, the vertical axis branches out to hold both ends of the horizontal axis.

Another mount that could be used with the present invention is an equatorial mount. An equatorial mount has two perpendicular axes of rotation: a right ascension axis and a declination axis. The right ascension axis, also called the polar axis, is in a generally north-south direction parallel to the Earth's rotation. The declination axis is in a generally east-west direction. Unlike the altitude-azimuth mount, neither axis in the equatorial mount is in a vertical position with respect to the ground. In one embodiment of the present invention, the telescope is attached to the declination axis, which is attached to the end of the polar axis in the shape of a “T.” In another embodiment, the polar axis branches into a fork that holds the declination axis. In yet another embodiment, the telescope may be attached to the polar axis. One of skill in the art will understand that further mount arrangements beyond these herein described may be incorporated into this operable invention.

The mount of the telescope system 100 is functionally attached to a motor to drive the positioning of the telescope 41, in one embodiment of the invention. The mount and motor are also coupled to a control system, such as a processor 42. The mount further includes one or more encoder portions to determine relative position of the telescope and the mount. One exemplary such encoder portion described further below, is referred to herein as “setting circles.”

Two types of motors suitable for use with the present invention are servo motors and stepper motors. Note, however, that the present invention would be operable with any type of motor or other motion control device capable of moving or rotating the shafts of the mount to position the telescope. Servo motors require a feedback device to communicate the rotation of the shaft. In one embodiment, the servo motor includes an electric motor and a position feedback variable resistor. Stepper motors, on the other hand, may be commanded to move in precise steps. In another embodiment of this invention, the stepper motor has a magnetized internal rotor. The stationary stator may contain four windings, each energizing a set of teeth. The axis turns in controlled steps as the windings are energized in sequence.

The telescope system 100 of the present invention may further include databases of information accessible via the processor 42 and usable in conjunction with user input to control operation of the telescope 41 via the motorized controls and other orientation features. The processor 42 can be incorporated in or include a personal computer (PC), telephone device, personal digital assistant (PDA), hand-held device, or other device. The processor 42 may be integrated into the telescope system 100 or may be remotely located and coupled (e.g., by wired, wireless, or fiber optic coupling) 50-55 to the telescope 41. The processor 42 thereby may allow remote receiving of data (e.g., image information) from the telescope 41 and remote input of positioning instructions and other information for use in control and operation of the telescope 41 and other components.

As shown in FIG. 3, the telescope 41 is coupled to a processor 42, contained, for example, in a PC, minicomputer, mainframe computer, microcomputer, or other device having a processor and a repository for data or connection to a repository for maintained data, via couplings 50-55 such as wired, wireless, or fiber optic couplings. FIG. 4 illustrates the telescope 41 wirelessly coupled 71 to a PDA, which is one variation of the device containing the processor 42.

In one embodiment, wireless coupling of the telescope to the PDA or other device containing the processor may be accomplished with a Bluetooth interface. In such a system, two electronic devices communicate via an RF frequency of approximately 2.45 GHz. The devices share a 1 Mbps channel, which hops frequency every 0.625 microseconds. Other possible methods of wireless communications include infrared and Wi-Fi links. In addition or in the alternative, the processor and the telescope may be coupled by a wired connection. In a typical embodiment, a cable is connected between RS-232 ports on the device containing the processor and the local controller at the telescope.

One software product to operate this connection from a personal computer is the Starry Night Pro™ version 5.0 sold by Imaginova. In this embodiment, the application software operates in conjunction communication software and protocol to transmit commands to the controls associated with the telescope, as well as receive feedback and other information from the telescope. The Starry Night™ software is just one example of application software. Other possible products that could be used include proprietary, shareware, and freeware software.

The telescope system 100 of the present invention also includes a user interface 47, wherein the user can input information to the system 100. User input is provided, for example, via a mouse, keyboard, keypad, touch screen, or other interface. In one embodiment, the telescope system 100 includes a display feature 44, such as a monitor (e.g., liquid crystal display (LCD)).

Some variations of the present invention include a camera component 45, such as a charge coupling device (CCD), for gathering light information (e.g., a digital image) from the telescope 41. The camera component 45 allows users to view images received by the telescope 41 at, for example, a remote location (e.g., via display feature 44 and processor 42) and to perform other functions, such as producing long exposures of received images or automatically orienting the telescope by aligning the gathered image with a stored database image. The camera component 45 may be used in connection with image processing software. In one variation, the telescope system 100 can create fixed images using a printing peripheral device 43. As an alternative to the long exposures described above, a sequence of short exposures may be produced. A sequence of short exposures enables correction of the received image in case of movement of the telescope during exposure.

The camera component comprises one or more sensors. Sensors operable with the present invention include but are not limited to photodiodes, bipolar phototransistors, and charge injection devices. In one embodiment of the present invention, the sensor is one or more arrays of MOS capacitors called charge coupled devices (CCD). Each capacitor accumulates charge in proportion to the intensity of the light directed onto it by the lens. These charges are shifted into a charge domain shift register, converted into a voltage, amplified, and stored into memory and/or displayed to create a pixel-based image. In order to create a color image, a color filter array may overlay the CCD. The color filter array masks out all but the desired color component for each pixel. In another embodiment of the present invention, the CCD is replaced by an array of CMOS active pixel sensors (APS). In the APS, charge is converted directed into voltage using a dedicated amplifier for each pixel. This enables direct reads of pixel values through row and column addressing. Commercially available CMOS sensors operable with the present invention are manufactured by Kodak, Mitsubishi, and Micron, among others.

In one embodiment of the present invention, the primary method for a user to view images through the telescope is via a camera component that replaces a conventional eyepiece normally used for the telescope. Such use of a camera component thereby reduces user difficulty normally experienced with viewing through a conventional eyepiece. In one embodiment, the camera allows real-time viewing, selection of a still image at a particular time, and other control of speed of image review, similar to control of video.

Another embodiment of the present invention includes both a conventional eyepiece for the telescope, allowing conventional viewing by the user, and a camera component, allowing remote viewing.

Yet another embodiment allows selective user replacement of the eyepiece by the camera component, to allow either conventional or camera viewing.

The present invention enables partially automatic or fully automatic orientation of the telescope. At least two different technologies may be used singly or in combination to accomplish this. In some embodiments, software is used with the telescope system 100. In one embodiment, this software includes a constellation reproduction or projection component usable by the present invention to match (e.g., via overlapping comparison) received light information from the telescope 41 with constellation information to allow automatic or fine-tuning of the orientation and/or focus of the telescope 100. The constellation projection software is also usable to allow the user to identify and/or select astral bodies or other astral information to be viewed (e.g., to cause the telescope 41 to automatically orient to a selected body).

Those of skill in the art are familiar with numerous algorithms capable of being performed in software or hardware to match received light with constellation information. The Star Tracker by Starvision Technologies, Inc., for example, includes software that enables an object such as a satellite to determine orientation solely using received star image data. One exemplary algorithm that may be used to perform this feature is described in Daniele Mortari's 1997 article “Search-less Algorithm for Star Pattern Recognition,” which was published in the Journal of the Astronautical Sciences, Vol. 45, No. 2, pp. 179-194, and is herein incorporated by reference. This two-part algorithm relies solely on angular separation to identify stars. Part one is a K-vector star pair identification technique and part two is a star matching identification technique. The software includes a master catalog of stars. In part one, the software identifies a small set of star-pairs likely to correspond to an observed star-pair's measured angular separation. This process is repeated or performed in parallel for multiple observed star pairs. In part two, the actually observed stars are identified, for example by determining which stars are members of at least one of the likely star pairs for multiple observed pairs sharing the same star. Once the star image data is properly identified, the orientation of the object receiving the data may be determined unambiguously from information in the catalog. The catalog identifies star positions by altitude and azimuth or any other known coordinate system. One possible telescope configuration suitable to operate with the described software is disclosed in U.S. Pat. No. 6,556,351, invented by Junkins et al., which is herein incorporated by reference. Junkins discloses an optical combiner that focuses optical data from two fields of view onto an image plane.

A second possible technology for partially or fully orienting the telescope does not require star image data. One example of this technology is described in U.S. Pat. No. 6,844,822, invented by Lemp, which is herein incorporated by reference. Lemp discloses a hand-held electronic celestial object-locating device with up to three or more sources of data input. The device includes one or more GPS receivers to determine its location. The device also includes a gravitational sensor comprising a single accelerometer with three orthogonal axes or three separate orthogonal accelerometers. The device also includes a three-axis magnetic field sensor. Collectively, the gravitational and magnetic field sensors produce data determining the orientation of the device. Note that in another embodiment, the gravitational and magnetic sensors may be replaced by at least two gyroscopes. The device also includes a processor containing a software feature that uses the data from these sensors.

Via this software feature, information from the GPS component 46, and information from other orienting components as well as time of day information, the telescope system 100 of the present invention provides the user with automated calibration and orientation in a coordinate system. Once the telescope system 100 is operational, the user can obtain location information for the telescope with the GPS component 46. The coordinates provided by the GPS 46 and other information (e.g., telescope orientation) are automatically processed by the processor 42, providing the user and telescope system 100 with a calibrated point of reference. Time of day is used to determine the celestial information viewable by the telescope at any given time (e.g., stars, planets, and other bodies visible at that point in the Earth's rotation).

In operation, the user is able to input a celestial body, for example, for the telescope 41 to target. One example of software usable with this feature is Starry Night® by Imaginova of New York, N.Y. The processor 42 directs the telescope 41 to move to an orientation so as to view the targeted celestial body, using this input information, the known position of the telescope 41, and the database of celestial information.

For example, the mount in one variation of the present invention includes a level, compass, and setting circles (e.g., digital setting circles). In one embodiment of the invention, digital setting circles include two encoders. Each encoder has a gear that communicates with the axial gear on a shaft of the mount. As the shaft rotates, the movement of the axial gear turns the encoder's gear as well. The encoders measure the movement of the shaft by measuring the movement of the gear. In the case of an optical encoder, the gear may contain an alternating pattern of light and dark lines radiating towards its outer edge. The encoder can then use a visual sensor to count the number of lines that have passed during a rotation. The number of lines determines the resolution of the encoder; for example, in one embodiment the encoder has 4000 lines, which provide a resolution of 0.09 degrees. Digital setting circles are indicators of the adjustments necessary to point the telescope to the desired target. In a typical embodiment, digital setting circles are controlled by a processor. The processor receives as input the initial orientation and position information derived from one of the two orientation technologies described above and/or the information from the encoders and compares them to the altitude and azimuth (or coordinates in any other coordinate system) of the desired target. The processor may graphically communicate to the user the adjustments necessary to point the telescope to the desired target, for example by the use of digital setting circles on the LCD screen, or it may automatically initiate the adjustments via a feedback control.

Such setting circles provide a coordinate system for the telescope's 41 orientation, (i.e., where the telescope 41 is pointing). Once the telescope system 100 is calibrated, the setting circles provide the user with information in several ways. For example, the user (e.g., while inside the user's home at a remote terminal) can determine what the telescope 41 is targeting, based on information provided by the setting circles, other position information, such as compass, level, and GPS (including time of day) information, and the accessed database of celestial information. If the telescope 41 is pointing in a particular direction, perhaps randomly selected by the user, the setting circles, other positioning information and database provide the user with information on what the telescope 41 is currently targeting. In addition, the user can automatically position the telescope 41 by inputting a particular object or coordinate points. For example, a user wishing to see the North Star inputs this information to the processor 42, and, in turn, the processor 42, setting circles, GPS, and other positioning information are used to position the telescope 41 automatically in the direction (and view) of the North Star. Similarly, the user may simply enter a set of coordinates, and the telescope system 100 moves such that the telescope 41 is oriented for the given coordinates.

For these functions, the setting circle and mount have numerous variations. For example, in one variation, the user selects a set of coordinates or a celestial body and then instructs the telescope 41 to position itself. In this variation, the mount and motor stop when the telescope 41 targets the specifically requested coordinates or celestial body (e.g., based on the setting circles).

In another variation, the mount and motor operate based on the user's activation. For example, once the user selects a set of coordinates or a celestial body, the setting circles display the orientation of the telescope 41 with respect to the requested target. The motor and mount may be used to move in the direction indicated by the setting circles. The user moves the motor and mount until the setting circle display indicates the telescope 41 is correctly in place.

FIG. 5 further illustrates, in pictograph format, operation of a telescope system in accordance with the present invention. As shown in FIG. 5, the telescope system of the present invention provides GPS and magnetic and gravitational sensors, along with advanced processing capability, for orienting and aligning the telescope portion of the system (e.g., optical tube assembly). In one embodiment, a built-in CCD or other imaging technology (e.g. an integrated CCD video and still digital camera) is provided to gather image information, and no eyepiece is provided. In other embodiments, the imaging technology is replaceable with an eyepiece, or an eyepiece is provided in addition to the imaging technology.

As further shown in FIG. 5, the system includes a built-in display and processing device, such as a color LCD screen and controller. In some embodiments, the telescope portion (e.g., built-in display and processing device and/or imaging technology) is coupled to a separate processor, such as a processor in a computer. The separate processor, for example, runs planetarium-type software, which allows recording of image information (e.g. for website publishing), and provides capability for external output (e.g., plugs into home theater system).

As is known, image capture with desired resolution and clarity is difficult for telescope applications due to the dark light conditions, remote distances, zoom levels, earth rotation, and telescope creep. In most systems to increase resolution in low light applications, the shudder is left open for added time so as to accumulate additional light. However, for telescope applications, extending the time that the shudder is open can cause significant blurriness in the captured image. For this reason, in some embodiments, the present invention uses an image stacking technique. The system captures several images in rapid succession with short duration shudder open times. Software is then used to stack or merge the images into one image. The software registers the images relative to each other to account for movement of the telescope between image captures. The final image has increased resolution and clarity. An example of such software is STARRY NIGHT™ ASTRO PHOTO SUITE™ offered by Imaginova.

The present invention provides a wide variety of uses for captured images from the telescope. For example, the captured images may be processed and stored on a user's computer for manipulation, printing, etc. using photo management software, such as PHOTOSHOP™. Further, the captured images may be used in conjunction with planetarium-type software, wherein the captured images are incorporated into the various views available in the planetarium software. In this manner, the user may view and interact with the captured images, as well as view the captured images relative to stored image data in the software. The images could also be incorporated into other types of viewing or gaming software. For example, the images could be placed into a gaming environment that would allow the user interact with the images, such a virtual travel to a captured image location or similar type game system.

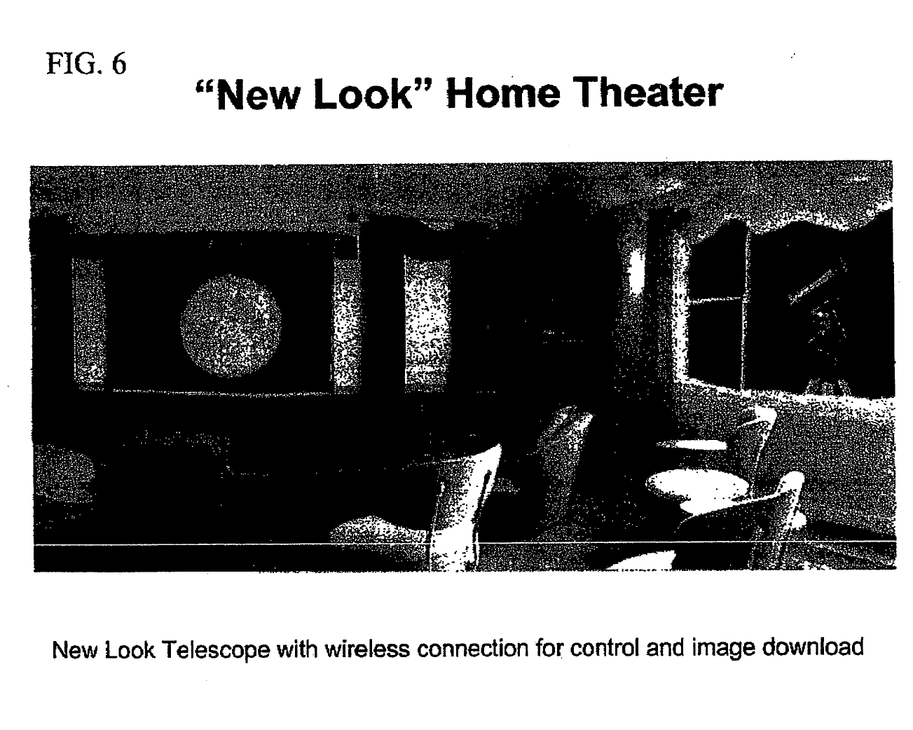

As another example, FIG. 6 presents an exemplary home theater system for use in conjunction with output from the telescope system of the present invention. In this system, captured images from the telescope may be output to the home theater, where they may be displayed as a real-time image or in a slide show format displaying previously captured images. Here again, various software packages, audio and video enhancements, etc. may accompany the images being displayed. As such, the system provides a home theater experience using captured images from the telescope.

As described above, the present invention allows a user to remotely interact with a telescope. The system auto-calibrates the telescope and then allows the user to control movements of the telescope remotely. The telescope may be connected directly to the user's computer, or connected via a wireless connection such as IR or RF. In one embodiment, the connection is via BLUETOOTH™ communication using communication software, such as BLUESTAR™ sold by Imaginova. In some embodiments, the communication may be via a network, such as a LAN, WAN, Internet, etc. For example, the telescope could be located at any location in the world and accessed and controlled via the network using TCP/IP protocol.

As mentioned, the system allows the user to control the telescope via an associated computer. Previous discussions focused on the ability of the user to control movements of the telescope and store, display, manipulate, etc. captured images. It is to be understood that the telescope can also be automatically controlled via software. For example, tracking software could be employed to control the telescope. The telescope could be pointed at a star or constellation of interest. Tracking software could then be employed to periodically reposition the telescope on the point of interest to thereby adjust for earth rotation, telescope creep, and other factors.

Another use for the system may be in providing tours or educational information. For example, software could be employed to control the telescope. The software could operate in conjunction with audio, video, and other presentation materials to provide a guided tour or educational program. As the tour proceeds, the software would control the telescope to move to different points of interest.

### Example Processing System Components and Functionality

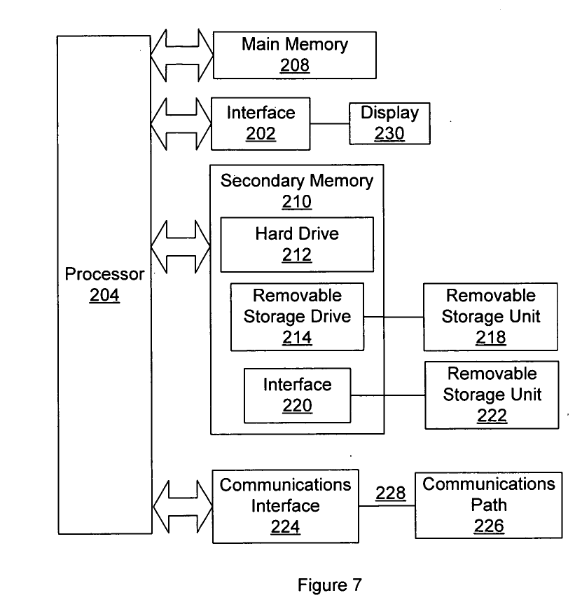

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 7.

Computer system 200 includes one or more processors, such as processor 42 or 204. The processor 204 is connected to a communication infrastructure 206 (e-g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

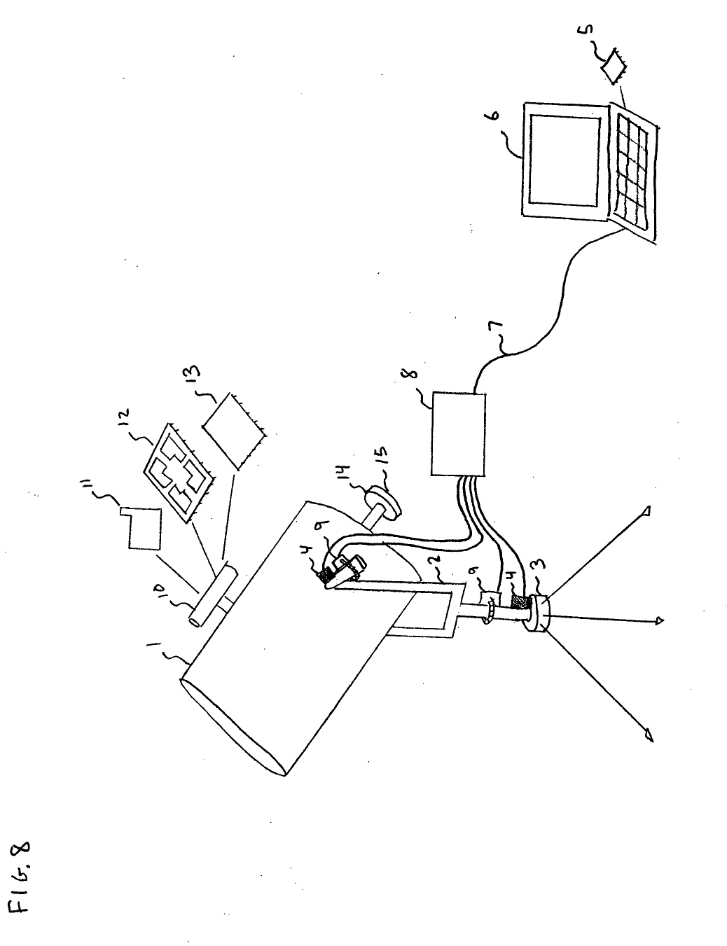

Referring to FIG. 8, a block diagram of one possible embodiment of the present invention is shown. The telescope 1 is positioned on an altitude/azimuth mount 2 having a vertical shaft and a horizontal shaft. Other types of mounts, including an equatorial mount, could be used in place of the altitude/azimuth mount. The mount optionally includes a tripod 3 or other device to hold the telescope steady and/or to increase its elevation. A motor 4 is attached to each shaft of the mount. The motor turns the shaft in response to a command from the processor 5. As shown in FIG. 8, this is a servo motor, but it alternatively could be a stepper motor or another type of angular motion control device. The processor is a component of a control device 6, which may be the computer system described above or any electronic device capable of performing computations and communications functions. Data are transferred between the processor and the motors by means of a cable 7, which connects from the computer system to a local controller 8 at the telescope. The cable may be connected by any mode known in the art, including serial and parallel connections, or it may be replaced by a wireless connection. The local controller sends commands to the motors. In one embodiment, the local controller comprises an electronic circuit board and a housing. One or more encoders 9 is attached to the telescope or the mount, preferably one encoder being attached to each shaft of the mount to measure the angular rotation. If a servo motor is being used as shown, the output of the encoder is fed back to the local controller to determine the appropriate commands to be sent to the motor to move the telescope to the desired position.

Continuing to refer to FIG. 8, the device 10 for orienting the telescope 1 is connected to the telescope or the mount. In one embodiment, the device for orienting may be attached in parallel to the telescope. As shown, the device for orienting includes a GPS receiver 11, a three axis accelerometer 12, and a three axis magnetic sensor 13. Magnetic, gravitational, and GPS time and location data may be used in a processor local to the telescope to perform calculations described above for calibration and orientation, or the data may be transmitted back to the processor via a cable 7 or wireless connection. In an alternative embodiment, device 10 could be replaced with software that compares received star image data to catalogs of stars and their positions as described above.

Again continuing to refer to FIG. 8, the image data from the telescope may be visible via an eyepiece. Additionally or in the alternative, the image data may be captured by a digital camera 14 and made visible via an LCD screen 14. The image data may be communicated to the control device 6 via the cable 7 or a wireless connection for processing, transmission or storage as requested by the user.

One of skill in the art will understand that the functions of the processor 6 may be divided between a first processor and a second processor. In one embodiment, the first processor is in a computer system as described above and the second processor is in a hand held controller for the convenience of the user.

One of skill in the art will also understand that the invention herein described may be permanently incorporated into a telescope, or may be available as a separate accessory to a telescope, for example as an after-market retrofit.

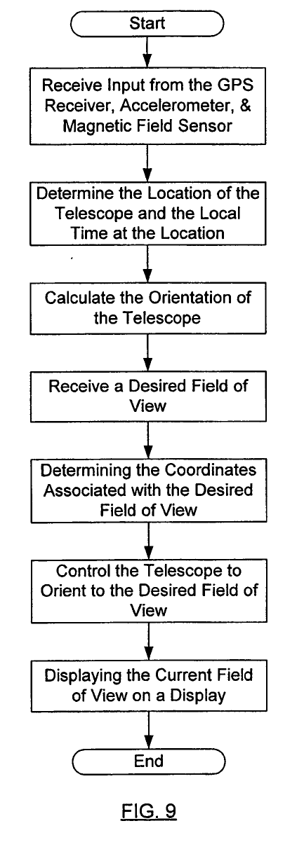

Referring to FIG. 9, a flowchart corresponding to a method for orienting the telescope of FIG. 8 is shown. With reference to block 300, the GPS receiver, accelerometer, and magnetic field sensor are polled. The processor uses the GPS data to determine the precise time and the location of the telescope. (See block 301). The processor determines the angular position of the telescope with the use of the gravitational data from the accelerometer. (See block 302). The processor calculates the orientation of the telescope with the use of the magnetic field data. (See block 303). Once the precise orientation of the telescope is known, the system has the ability to alter the telescope's field of view to include any visible celestial object. For example, the user may input into the processor the desired celestial object to be viewed using application software such as Starry Night™. (See block 304). The processor then accesses an internal catalog in memory to determine the coordinates of the object in the telescope's field of view at the current time and the telescope's current location and orientation. (See block 305). Alternatively, the user may enter the coordinates to which the telescope is to be pointed. These coordinates may be sent directly to the local controller. In an alternative embodiment, the processor may send the local controller the relative difference between the current coordinates and the desired coordinates. The local controller uses the coordinates sent from the processor and feedback from the encoders on the mount shafts to command the motors to rotate the shafts to point the telescope to the desired coordinates. (See block 306). As these steps are performed, the image data currently in the telescopes field of view may be displayed on the LCD screen and/or sent to the processor. (See block 307).

One of skill in the art will understand that the steps of the method shown in FIG. 9 may be reordered substantially. For example, the user may specify the object to be viewed or the coordinates to which the telescope is to be pointed before polling the data sensors. Similarly, the processor may poll the data sensors in any sequential order or simultaneously.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for calibrating a telescope comprising:
a telescope for providing a field of view, said telescope connected to a substantially stationary mount;
a control system coupled between the mount and said telescope for orienting the telescope;
a position sensing system associated with said telescope for determining at least a geographic location of the telescope; and
an orientation sensing system associated with said telescope for determining the orientation of the telescope,
wherein said control system receives information from said position sensing system and said orientation sensing system to determine an initial position and orientation of the telescope.

2. A system according to claim 1, wherein said control system comprises one or more motors positioned to alter at least one of a rotational position and elevation of the telescope.

3. A system according to claim 2, wherein said control system further comprises a controller coupled to said one or more motors for controlling the operation of said motors.

4. A system according to claim 1, wherein said position system comprises a GPS receiver, wherein said GPS receiver determines a geographic position of the telescope.

5. A system according to claim 4, wherein said GPS receiver determines a time of day at the position of the telescope.

6. A system according to claim 1, wherein said orientation sensing system comprises one or more encoders associated with a positional platform.

7. A system according to claim 1, wherein said orientation sensing system comprises a compass.

8. A system according to claim 1, wherein said orientation sensing system comprises a gravitational device for sensing the gravitational forces on the telescope to thereby determine the orientation of the telescope.

9. A system according to claim 1, wherein said orientation system comprises:
a storage system, said storage system comprising data identifying one or more stars or constellations;
a processor in communication with said telescope and said storage system, said processor capable of receiving data representing light signals from a current field of view of the telescope and comparing the light signals to the stored data identifying the one or more stars or constellations to determine the current orientation of the telescope.

10. A system according to claim 1, wherein said orientation system comprises:
a storage system, said storage system comprising data identifying one or more stars or constellations;
a processor in communication with said telescope and said storage system, said processor capable of receiving data representing light signals from a current field of view of the telescope and determining angular separations between one or more stars identified in the field of view and comparing the angular separations to the stored data identifying the one or more stars or constellations to determine the current orientation of the telescope.

11. A system according to claim 1, wherein said control system orients said telescope based on input from a user indicating a desired field of view.

12. A system according to claim 11 further comprising an interface capable of providing various fields of view to a user, wherein after the user selects a desired field of view, said interface transmits the desired field of view to said control system.

13. A system according to claim 1 further comprising a digital image capture device associated with said telescope to capture a field of view of the telescope.

14. A system according to claim 13 further comprising a monitor associated with said digital image capture device for displaying images output by said digital image capture device.

15. A system according to claim 13 further comprising a television associated with said digital image capture device for displaying images output by said digital image capture device.

16. A system according to claim 15 further comprising audio and video equipment associated with the television to provide audio and video inputs to accompanying images from said digital image capture device.

17. A system according to claim 1 further comprising a communication system associated with said control system, positioning system, and orientation system to allow for communication between the systems.

18. A system according to claim 17 wherein said communication system comprises transceivers for wireless communication between one or more of the control, positioning, and orientation systems.

19. A system according to claim 18, wherein said communication system employs BLUETOOTH protocol for wireless communications.
